(19) United States
(12) Patent Application Publication
(10) Pub. No.: US 2013/0047529 A1
(43) Pub. Date: Feb. 28, 2013

(54) ACCESS FLOOR PANEL

(71) Applicant: Glenn Foden, Etobicoke (CA)

(72) Inventor: Glenn Foden, Etobicoke (CA)

(21) Appl. No.: 13/457,466

(22) Filed: Apr. 26, 2012

(30) Foreign Application Priority Data
Aug. 24, 2011 (CA) 2751353

(51) Int. Cl. E04F 15/024; B32B 15/04; E04B 5/43

(52) U.S. Cl. 52/220.1; 52/745.13; 428/457; 428/332

(57) ABSTRACT

An access floor panel may have a core panel placed between a top pan and a bottom pan. The top pan and the bottom pan may be made from metal and may be formed around the core panel. The top pan may have a coating applied thereto, the coating may have one or more of several advantageous properties such as fire resistance, electrostatic dissipation properties, slip resistance, wear resistance and the like. In an embodiment, the coating may also have a predetermined surface pattern to give the panel an aesthetically pleasing look.

### FIELD OF THE INVENTION

The invention relates to flooring systems, and more particularly to access flooring systems for computing environments.

### BACKGROUND

Access flooring systems are commonly used in buildings where access may be required to cabling such as electric, networking and phone cabling, and heating, ventilation and air conditioning (HVAC) equipment.

Access flooring systems often comprise a plurality of metal-clad floor panels supported by a number of supports posts over a structural floor. The metal-clad panels are generally arranged so that they abut to each other in an end to end fashion so that a continuous floor is created that is raised above the structural floor. The access floor in some cases is made up of metal-clad panels, vent panels, transparent panels and the like. A carpet is often laid on top of the access floor panels.

Access panels for computer rooms involve several unique challenges. For example, computer rooms may require access panels that are slip-resistant and also provide electrostatic discharge (ESD) properties. Metal-clad floor panels are often used in computer rooms because of their static dissipation properties. One such metal-clad panel is constructed from a composite core that is covered with a steel top pan and bottom pan.

A prior art access floor panel is shown in FIG. 1a,b. The prior art floor panel has a core panel placed in between a metal top pan and metal bottom pan. A high pressure laminate (HPL) is adhered to the top pan and a trim edge is applied. Other surface finishes are often applied to prior art panels such as vinyl, wood, rubber, etc.

Prior art panels unfortunately suffer from disadvantages, some of which include the cost of applying the surface finish, delamination between the HPL (or other surface finish) and protection of the brittle edge of the HPL with costly vinyl trim or additional routing process. Delamination is a particular problem and results from the different coefficients of thermal expansion between the top pan and the HPL. As the temperature changes in a given environment, the HPL often becomes delaminated from the top pan, which reduces the lifespan of the panels and necessitates replacement or repair of the panels.

There is therefore a need for an access floor panel which overcomes or mitigates one or more of the defects of the prior art.

### SUMMARY OF THE INVENTION

In its broad aspect, the invention provides an access floor panel suitable for use in a computing environment such as a data center. The access floor panel includes a core panel, a top pan and a bottom pan. The top pan and the bottom pan may be made from a metal such as steel. The top pan includes a coating that has static dissipative properties. The coating may also be fire-resistant, scratch resistant, wear resistant, etc.

In another aspect, the invention provides a method for assembling an access floor panel. The method may include the steps of providing a core panel having a top side and a bottom side, providing a top pan made out of a suitable material such as metal, providing a bottom pan made out of a suitable material such as metal and forming the top and bottom pans onto the core panel.

In yet another aspect, the coating applied to the top panel may have a predetermined aesthetic surface pattern.

In another aspect, the invention provides an access flooring system. The access flooring system may include a plurality of support posts adapted to receive at least one access floor panel. A pedestal may be placed on each support post for resting the access floor panels thereupon.

In an aspect, the coating is applied to the top pan before the top pan is formed on the core panel.

In one aspect, the core panel may be made from composite board material such as non-urea, particle board, medium or high density fiberboard, strawboard, cement board, concrete board, fire resistant materials and the like.

In another aspect, the area of the top pan is larger than the top side area of the core panel so that the portion of the top pan that extends beyond the top side of the core panel can be bent around the core panel.

### DESCRIPTION OF THE DRAWINGS

The invention will be better understood with reference to the drawings, in which:

FIG. 1a is a diagram illustration of a floor panel of the prior art that includes a high pressure laminate; FIG. 1b is a cross-sectional illustration of the prior art floor panel of FIG. 1a;

FIG. 2 is a diagram illustration of an embodiment of an access floor system of the invention;

FIG. 3 is a diagram illustration of another embodiment of an access floor system of the invention;

FIG. 4 is a diagram illustration showing an isometric view of an access floor panel of the invention; and

FIG. 5 is a side view of an access floor panel of FIG. 4.

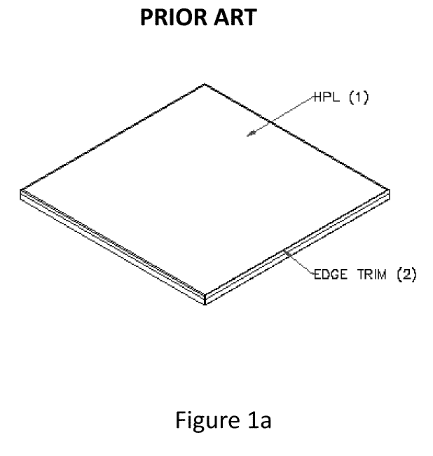

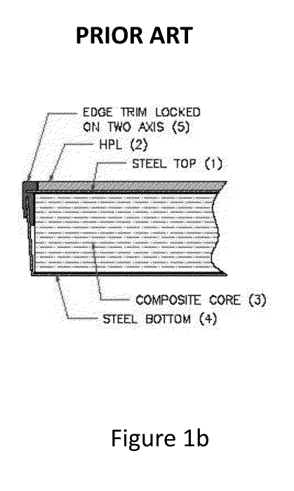

Like reference numbers and designations in the various drawings indicate like elements.

### DETAILED DESCRIPTION

An access floor panel 100 may be formed from a core panel 104, a top pan 102 having an advantageous coating 108 and a bottom pan 106 resulting in an access floor panel 100 that provides benefits in many environments, including computer rooms.

The access floor panel 100 of the present invention provides properties that are advantageous for use in access flooring systems. In an embodiment, the access floor panel 100 may provide slip-resistant, electrostatically dissipative, fire resistant, scratch resistant and/or other advantageous properties.

In one embodiment, the access floor panel 100 may include a composite core panel 104 that has a top side 120 and a bottom side 122. The top side 120 is adapted to provide support for people and equipment that may be placed on the access floor panel 100. A top pan 102 may be positioned on the top side 120 of the core panel 104 and bottom pan 106 may be positioned on the bottom side 122 of the core panel 104. The top pan 102 may comprise metal such as steel, as may the bottom pan 106. In an embodiment, the top pan 102 and the bottom pan 106 are approximately 0.02 inches in thickness plus or minus 0.002 inches, although other thicknesses and tolerances may also be used. An advantageous coating 108 may be applied to the top pan 102, the coating 108 having one or more of the following properties: slip-resistance, electrostatic dissipation, fire resistance, and a pre-determined surface pattern. In an embodiment, the coating 108 is applied to the top pan 102 before the top pan 102 is placed on the top side 120 of the core panel 104. The coating 108 may be applied to one or both sides of the top pan 102. In one embodiment, the coating 108 is applied to one side of the top pan 102 after the top pan 102 is placed on the top side 120 of the core panel 104.

In some exemplary embodiments, the coating 108 is a substance that is not too conductive but will slowly conduct static charges away. The coating 108 may be selected to slowly conduct static charges away from sensitive equipment, and in some exemplary embodiments, the coating 108 has resistivity values in the range of 10⁵ to 10¹⁰ ohm-meters. The coating 108 may be applied to the top pan 102 using one or more of several methods, such as but not limited to, spraying, brushing, rolling, dipping the pan in a container having the coating 108, and the like.

In an embodiment, the core panel 104 may be formed from various composite board materials.

In an embodiment, a person may select a surface pattern from variety of known surface patterns or the person may create their own surface pattern to increase the attractiveness of the floor panel 100.

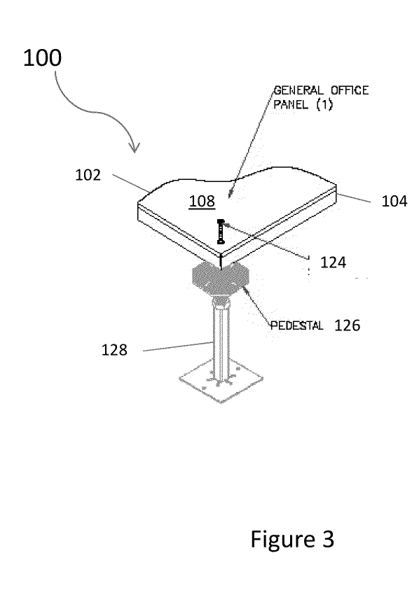

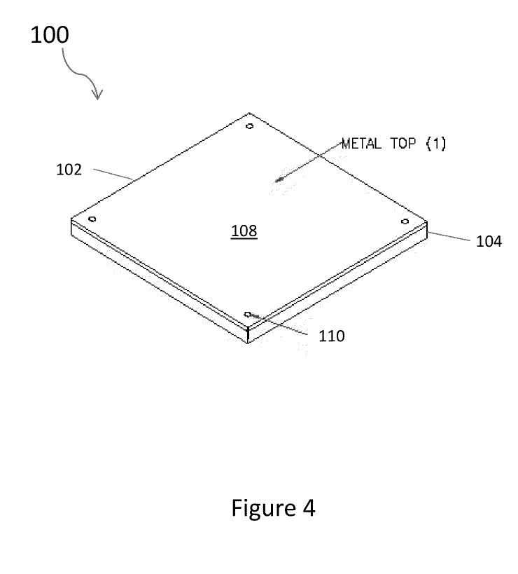

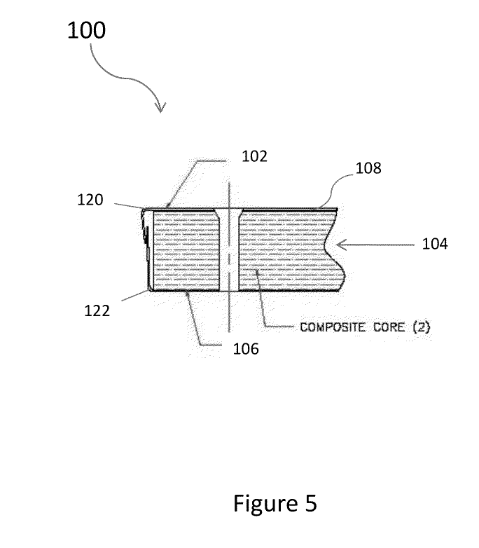

In an embodiment, the invention provides a method for assembling an access floor panel 100. The method includes the step of providing a core panel 104 having a top side 120 and a bottom side 122. The core panel 104 may be made from composite board material. The method may include the step of providing a top pan 102 and a bottom pan 106. The top pan 102 and/or the bottom pan 106 may be made from a metal such as steel. In an embodiment, the top pan 102 and the bottom pan 106 are slightly larger than the core panel 104 in surface area which enables forming of the top pan 102 and the bottom pan 106 according to the layout shown in FIG. 3. In an embodiment, the forming of the bottom pan 106 may involve bending a portion of the bottom pan 106 that extends beyond the bottom side 122 of the core panel 104 along the side of the core panel 104. Similarly, forming of the top pan 102 may involve bending a portion of the top pan 102 that extends beyond the top side 120 of the core panel 104 along the side of the core panel 104. In embodiment, such as is shown in FIG. 3, the top pan 102 may be formed after the bottom pan 106 is formed, thus allowing the top pan 102 to overlap the bottom on the side of the core panel 104 which provides the advantage of holding the bottom pan 106 in place. The forming of the top and bottom pan 106 may be done in a forming die and press.

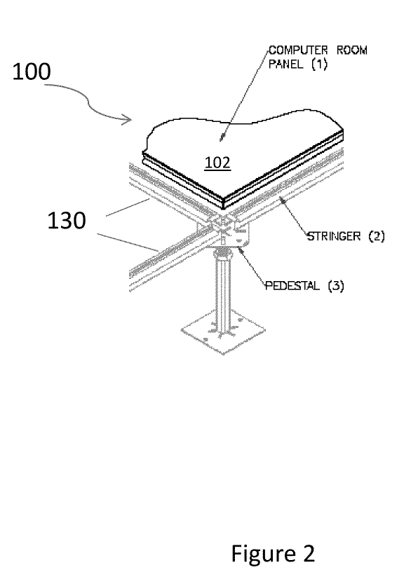

In one embodiment, the invention provides a system for assembling an access floor suitable for use in a computer data room. The system may include a structural floor and a plurality of support posts 128 adapted to support at least one access floor panel 100. As shown in FIG. 2, each support post 128 may be positioned below a pedestal 126, the pedestal 126 being configured to support up to four stringers 130. Four stringers 130 may be configured to support an access panel. The access panel of one system of the invention may include a core panel 104, top pan 102 having an advantageous coating 108, and a bottom pan 106 as is described above.

In one embodiment, a system of the invention uses a plurality of support posts 128, each support post 128 having a pedestal 126. An access panel may be placed on a plurality of pedestals 126 suitably arranged (as shown in FIG. 3) and the access panel may be secured to the plurality of pedestals 126 with corner bolt screws 124. The access panel may be provided with holes 110 for the corner bolt screws 124 during the assembly process of the access panel.

Some or all of the material used in a system of the invention may be made of dissipative material, and the dissipative material may be grounded.

The system may provide a continuous path between the top pan 102 of the access panels and the ground to facilitate static to discharge to the ground. This helps discharge any static charge which a worker has built up, as well as any static charge on tools or exposed components that are placed on the access panels. In embodiment, the static dissipative coating 108 on the top pan 102, the bottom pan 106, the supports posts 128 and the pedestal 126 may together or in part provide a continuous discharge path to the ground. As will be appreciated, the ground path may be provided with a pre-determined resistance or range of resistances so that static is discharged at a pre-determined rate that is suitable for computing environments.

In one exemplary embodiment, the panel 100 is assembled by firstly running the composite board core 104 through a roll coater which applies an adhesive to both top 120 and bottom surface 122, then the composite core 104 is placed into the formed bottom pan 106 and then the top pan 102 is placed on top of the composite core 104. The assembly of top pan 102, the core 104, and bottom pan 106 are then fed through a nip roll which applies pressure to the assembly 100 and fuses the parts together. The part 100 is then left for a period of time (such as for example, 24 hours) for the adhesive to cure. Once cured the assembled panel 100 is then formed to final size and corner holes 110 drilled if desired. A coating 108 with statically dissipative properties is then applied to the top pan 102, and in some embodiments, to the bottom pan 106 as well. In another embodiment, the coating 108 is applied to the top pan 102 and/or the bottom pan 106 before the pans are attached to the core panel 104.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

1. An access floor panel comprising:
a composite core panel comprising a top side and a bottom side,
a top pan comprising steel positioned on the top side of the core panel,
a bottom pan comprising steel positioned on the bottom side of the core panel,
wherein the top pan comprises a coating with electrostatic dissipative properties.

2. An access floor panel according to claim 1 in which the coating has slip-resistant properties

3. An access floor panel according to claim 1 in which the coating comprises paint with ink and protective clear coating.

4. An access floor panel according to claim 1 in which the core panel comprises composite board core fiberboard.

5. An access floor panel according to claim 1 in which the top pan comprises metal.

6. An access floor panel according to claim 5 in which the top pan is approximately 0.02 inches in width.

7. An access floor panel for use in computing environments, the floor panel comprising:
a composite core panel comprising a top side and a bottom side,
a top pan positioned on the top side of the core panel,
a bottom pan positioned on the bottom side of the core panel,
wherein the top pan comprises a coating with electrostatic dissipative properties, the coating comprising a pre-determined surface pattern.

8. An access floor panel according to claim 7 in which the coating is substantially fire resistant.

9. An access floor panel according to claim 7 in which the top pan comprises metal.

10. An access floor panel according to claim 9 in which the metal comprises steel.

11. An access floor panel according to claim 10 in which the core panel comprises composite board core.

12. An access floor panel according to claim 11 wherein the coating has a resistivity value in the range of 10⁵ to 10¹⁰ ohm-meters

13. An access floor system for providing access to cabling beneath a floor, the system comprising:
a structural floor;
a plurality of support posts extending substantially upward from a structural floor;
at least one floor panel supported on said plurality of support posts, said at least one floor panel comprising:
a composite core panel comprising a top side and a bottom side,
a top pan comprising steel positioned on the top side of the core panel,
a bottom pan comprising steel positioned on the bottom side of the core panel,
wherein the top pan comprises a coating with electrostatic dissipative properties.

14. A system according to claim 13, in which the top and bottom pans provide a ground return path.

15. A method for assembling an access floor panel, the method comprising:
providing a core panel having a top side and a bottom side, providing a top pan comprising metal; providing a bottom pan comprising metal; applying a coating with electrostatic dissipation properties to the top pan; forming the bottom pan on the bottom side of the core panel; and forming the top pan on the top side of the core panel.

16. A method according to claim 15 wherein providing a top pan comprising metal includes providing a top pan with an area larger than the top side area of the core panel.

17. A method according to claim 16 wherein providing a bottom pan includes the step or providing a bottom pan with a surface area larger than the area of the bottom side of the core panel.

18. The method according to claim 15 further including the step of applying a coating with slip-resistant properties to the top pan.

19. The method according to claim 15 further including the step of applying a pre-determined surface pattern to the top pan.
